(19) United States
(12) Patent Application Publication
(10) Pub. No.: US 2023/0049749 A1
(43) Pub. Date: Feb. 16, 2023

(54) Resource Provisioning Based on Estimation of Risk

(71) Applicant: People Center, Inc., San Francisco, CA (US)

(72) Inventors: Charles Matthew MacInnis, San Francisco, CA (US); Sowmya Ranganathan, San Francisco, CA (US); Prashant Upadhyay, Vasant Kunj-New Delhi (IN)

(21) Appl. No.: 17/402,089

(22) Filed: Aug. 13, 2021

(51) Int. Cl. G06F 21/57; G06F 9/50

(52) U.S. Cl. CPC G06F 21/577; G06F 9/5005; G06F 2221/034

(57) ABSTRACT

Methods, systems, devices, and tangible non-transitory computer readable media for resource provisioning based on risk scores. The disclosed technology can include accessing resource request data including information associated with a request for a resource from an entity associated with an organization. Organizational data associated with the entity can be accessed. The organizational data can include information associated with risk factors and previous resource allocations of the entity. Based on performance of risk evaluation operations on the organizational data, a risk score associated with provisioning the resource to the entity can be determined. A resource provisioning amount can be determined based on the risk score. The resource provisioning amount can include an amount of the resource authorized to be provisioned to the entity. Furthermore, output including indications associated with the resource provisioning amount can be generated.

### FIELD

The present disclosure relates generally to resource provisioning based on risk scores. More particularly, the present disclosure relates to determining an amount of resources to provide to an entity based on an estimate of risk associated with the entity.

### BACKGROUND

Computing systems can be used as platforms via which resources can be distributed to, by, and/or on behalf of various entities. The distribution of these resources can involve the use of risk assessments to determine the amount of a particular resource that may be distributed to any given entity or user of the platform.

As such, increasing the ease with which entities can request resources and have those resources securely allocated to them can lead to a reduction in the amount of friction associated with such resource allocations. Accordingly, there exists a demand for a more effective way of determining an amount of a resource to allocate to an entity or user based on an assessment of the risk associated with that entity or user.

### SUMMARY

Aspects and advantages of embodiments of the present disclosure will be set forth in part in the following description, or can be learned from the description, or can be learned through practice of the embodiments.

One example aspect of the present disclosure is directed to a computing system for resource provisioning. The computing system comprises: one or more processors; and one or more non-transitory computer-readable media that store instructions that, when executed by the one or more processors, cause the computing system to perform operations. The operations can include accessing resource request data including information associated with a request for a resource from an entity associated with an organization. The operations can include accessing organizational data associated with the entity. The organizational data can include information associated with one or more risk factors of the entity and one or more previous resource allocations of the entity. The operations can include determining, based at least in part on performance of one or more risk evaluation operations on the organizational data, a risk score associated with provisioning the resource to the entity. The operations can include determining a resource provisioning amount based at least in part on the risk score. The resource provisioning amount can include an amount of the resource authorized to be provisioned to the entity. The operations can include generating output including one or more indications associated with the resource provisioning amount.

One example aspect of the present disclosure is directed to a computer-implemented method of resource provisioning based on risk scores. The computer-implemented method can include accessing, by a computing system comprising one or more processors, resource request data including information associated with a request for a resource from an entity associated with an organization. The computer-implemented method can include accessing, by the computing system, organizational data associated with the entity. The organizational data can include information associated with one or more risk factors of the entity and one or more previous resource allocations of the entity. The computer-implemented method can include determining, by the computing system, based at least in part on performance of one or more risk evaluation operations on the organizational data, a risk score associated with provisioning the resource to the entity. The computer-implemented method can include determining, by the computing system, a resource provisioning amount based at least in part on the risk score. The resource provisioning amount can include an amount of the resource authorized to be provisioned to the entity. The computer-implemented method can include generating, by the computing system, output including one or more indications associated with the resource provisioning amount.

Another example aspect of the present disclosure is directed to one or more tangible non-transitory computer-readable media storing computer-readable instructions that when executed by one or more processors cause the one or more processors to perform operations. The operations can include accessing resource request data comprising information associated with a request for a resource from an entity associated with an organization. The resource can include access to payroll service portion of an organizational management platform. The operations can include accessing organizational data associated with the entity. The organizational data can include information associated with one or more risk factors of the entity. The operations can include determining, based at least in part on performance of one or more risk evaluation operations on the organizational data, a risk score associated with provisioning the resource to the entity. The operations can include determining a resource provisioning amount based at least in part on the risk score. The resource provisioning amount can include an approved level of access for the entity to the payroll service portion of the organizational management platform. The operations can include generating output comprising one or more indications associated with the resource provisioning amount.

In some examples, the approved level of access for the entity to the payroll service portion of the organizational management platform comprises a zero access level of access. For example, if the risk score fails to satisfy a certain threshold, then the entity can be denied access to the payroll service portion of the organizational management platform.

In some examples, determining the resource provisioning amount based at least in part on the risk score can include selecting one of a number of different payroll service product types for the entity based at least in part on the risk score. For example, the entity can be assigned to one or more of various products or tools which have different levels of risk associated therewith (e.g., a two-day payroll vs. a four-day payroll).

Thus, the risk score can be used to determine: whether an entity is able to access a payroll service product at all; if access is granted, which of a number of different products or tools may be available; and/or an amount of a resource which can be provisioned within the context of a provisioned product or tool.

Other aspects of the present disclosure are directed to various systems, apparatuses, non-transitory computer-readable media, user interfaces, and devices for resource provisioning based on estimation of risk.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations according to example embodiments of the present disclosure.

FIG. 2 depicts a block diagram of an example of a computing device according to example embodiments of the present disclosure.

FIG. 3 depicts an example of a graphical user interface for resource provisioning based on risk scores according to example embodiments of the present disclosure.

FIG. 4 depicts an example of output associated with resource provisioning based on risk scores according to example embodiments of the present disclosure.

FIG. 5 depicts a flow diagram of allocating resources based on risk scores according to example embodiments of the present disclosure.

FIG. 6 depicts a flow diagram of allocating resources based on risk scores according to example embodiments of the present disclosure.

FIG. 7 depicts a flow diagram of allocating resources based on risk scores according to example embodiments of the present disclosure.

FIG. 8 depicts a flow diagram of allocating resources based on risk scores according to example embodiments of the present disclosure.

FIG. 9 depicts a flow diagram of allocating resources based on risk scores according to example embodiments of the present disclosure.

FIG. 10 depicts a flow diagram of allocating resources based on risk scores according to example embodiments of the present disclosure.

FIG. 11 depicts a flow diagram of allocating resources based on risk scores according to example embodiments of the present disclosure.

Reference numerals that are repeated across plural figures are intended to identify the same features in various implementations.

### DETAILED DESCRIPTION

The present disclosure is generally directed to provisioning resources based on an estimation of risk. In particular, example aspects of the present disclosure are directed to a computing system that can be used to determine an amount of resources to provision to an entity based on an estimate of the risk associated with provisioning the resource to or on behalf of the entity. Further, the computing system described herein can provide specific benefits to the secure provisioning of resources to entities. For example, the disclosed technology can facilitate the estimation of risk associated with a request for funds by an organization or an employee of an organization. In this way, an organizational management platform can more effectively provision resources, including funds, to its users, such as various organizations or employees of organizations.

Example aspects of the present disclosure are directed to an organizational management platform that controls and leverages organizational data to enable the automatic estimation of risk and provisioning of resources for different users (e.g., organizations or employees of organizations) or groups of users (e.g., groups of organizations or groups of employees). In particular, an organizational management platform can control and leverage organizational data to manage organizational applications such as payroll, operations, human resources (e.g., onboarding and offboarding), benefits, information technology and device management, third-party application integration and access, and many others.

In particular, in some implementations, the organizational management platform can include tools which enable users (e.g., organizations such as corporate users) to perform payroll with respect to their employees, contractors, and/or other payees. In some implementations, performing payroll can include management, generation, and/or processing of timesheets, wage calculations, paychecks, direct deposits, and/or tax payments. For example, the organizational management platform can perform payroll by facilitating allocation of resources such as fungible currencies from one or more resource pools or accounts associated with the organizational management platform to various employees, contractors, and/or parties on behalf of the organization (e.g., as compensation for work or activities performed for the organization). Thus, performance of payroll can include transfer or allocation of resources to various parties on behalf of the organization, by means of the organizational management platform.

To facilitate performance of such payroll for an organization or other entity, the organizational management platform can assess a risk score associated with the organization. Example techniques for assessing a risk score are described throughout the present disclosure, and can include evaluating past and present attributes, characteristics, and/or performance of the organization such as prior pay run amounts by the entity, number of contractors, payment history, etc. The organizational management platform can use the risk score determined for the entity to make various decisions, such as, for example, whether to perform certain payroll operations on behalf of the entity at all and, if so, various thresholds or amounts of resources which can be allocated to, by, and/or on behalf of the entity and/or its employees or contractors. As one example, the organizational management platform can assign the entity to one or more of various products or tools which have different levels of risk associated therewith (e.g., a two-day payroll vs. a four-day payroll). As further examples, the organizational management platform can determine how much of a balance an entity may be required to have in an associated pool or account of resources; a style of resource allocation which may be used by the organization (e.g., direct wire vs. automated clearing house); and/or a number of pay cycles for which various determinations will be maintained or re-evaluated.

More generally, the organizational management platform can hold, for each of one or more organizations, a centralized set of organizational data that acts as a single, centralized system of record for all organizational management processes for that organization. Each organization can include a number of users which are able to access and interact with the organizational management platform. Some users may have administrative permissions that define whether the user is able to access and/or modify certain types of organizational data for their organization.

The organizational data for each organization can include data directly entered into the organizational management platform and/or can include data retrieved, pulled, or otherwise obtained from one or more first party and/or third-party applications with which the organizational management platform may have varying levels of integration. This ingestion and storage of data from third-party applications is in contrast to systems which simply sit on top of third-party applications and apply rules at run time. In some implementations, the organizational management platform can provide a user with the ability (e.g., by configuring Simple Mail Transfer Protocol (SMTP) settings) to configure the cadence or periodicity at which the organizational management platform receives or ingests data (e.g., via .csv files) from third-party applications.

The organizational data can, in some implementations, be held as one or more object databases. For example, multiple object classes can be defined in the object databases. Example object classes include employees, devices, job candidates, benefits policies, documents, pay instances, time cards, and/or other objects. For each object, values can be provided and maintained for one or more attributes, such as location, role, salary, etc. Links can be made between different objects. For example, one or more device objects can be associated with employee objects.

The object database(s) can be represented as or can store data which can be represented as one or more graphs with nodes that correspond to objects and edges that correspond to links or logical associations between objects and/or object attribute(s). Graph(s) can be traversed to understand or leverage relationships among objects and their attribute(s). In one example, the organizational data can be synthesized into a single graph which includes multiple classes of objects and defines complex relationships among objects and their attribute(s). For example, all workflows, including payroll, IT, etc. can be run through one platform and graph.

In some implementations, the organizational data can include organizational structure data. For example, the organizational structure data can be encoded within links or edges defined between objects of the organizational data or can be stored as a separate data layer. For example, the organizational structure data can define organizational relationships between objects, including employee objects. As one example, the organizational structure data may indicate that a first employee object has the relationship of “manager” relative to a second employee object. The organizational relationships can be defined between specific objects and/or groups of objects. As another example, the organizational structure data may indicate that a first group of employees (e.g., the “IT Administrator” group of employees) has a certain set of permissions (e.g., device activation/deactivation) relative to a particular group of devices (e.g. the “work laptops” group of the devices). Further, the organizational relationships may be used to determine an employee's access to resources including an amount of a resource that can be provisioned to the employee.

According to one example aspect, an administrator or other user of the organizational management platform can be enabled to define risk factors and previous resource allocations of entities or employees that can be stored in the organizational data. The risk factors can include, for example, factors associated with the risks of providing the entity or employee with varying amounts of funds.

In some implementations, the security policy computing system can include a graphical user interface that provides an easy way for an entity or an employee of an entity to request a resource. For example, a user can enter their identity and an amount of a resource that is requested via the graphical user interface. In this way, the potentially complicated process of filling out forms and passing through various levels of bureaucracy can be avoided or significantly reduced. Instead, the user can use a streamlined user interface that allows the user to request some amount of a resource from an organization.

By way of example, a computing system implementing the disclosed technology can access resource request data that includes a request for resources, from an organization or employee of an organization. For example, an organization or employee can request advance payment of funds owed to or payable on behalf of the organization or employee ahead of the organization or employee's scheduled payment date. The computing system can then access organizational data that includes information associated with risk factors and previous resource allocations of the organization or employee. Further, the computing system can perform risk evaluation operations by using the organizational data including the organization or employee's history of repayment of loans to estimate the risk associated with providing the organization or employee with the requested amount of a resource or supplying the requested amount of the resource on behalf of the organization or employee. Additionally, based on the risk score, the computing system can use the risk score to determine a resource provisioning amount that the organization is authorized to provide to the organization or employee. The computing system can then provide an output to indicate how much of the resource can be provided to the organization or employee. For example, the computing system can include a graphical user interface that displays a message indicating an amount in dollars that the organization or employee can receive.

Accordingly, the disclosed technology may improve the effectiveness with which risk is estimated and appropriate resources are provisioned. In particular, the disclosed technology can facilitate the resource request process via a user friendly interface through which an authorized user can request resources without the burdensome. Further, the disclosed technology can leverage organizational data as the basis for estimating risk, by pulling relevant information from one or more organizational records that may be structured in a way that allows for the efficient determination of an appropriate amount of a resource to provision to a requesting organization or employee of the organization.

The computing system can receive, access, obtain, and/or retrieve resource request data. The resource request data can include information associated with a request for a resource from an entity associated with an organization. The resource request data can include an identifier associated with the entity (e.g., a personal name and/or alpha-numeric code) that can be used to identify the entity. Further, the resource request data can include an amount of the resource (e.g., a dollar amount) being requested, a location associated with the entity (e.g., the geographic location of the entity in which the geographic location can include a nation or state), a location associated with the organization (e.g., a geographic location of an organization's headquarters, an organizational office that will provide resources to the entity, or a third-party's location at which the resource will be provided), and/or a time indicating when the entity requested the resource.

Further, the resource can include any type of resource that can be exchanged and/or used as payment for goods and/or services. For example, the resource can include any amount of money/currencies, equities (e.g., stocks in the organization), and/or bonds. Additionally, the resource can be associated with a singular amount of property (e.g., a one (1) kilogram bar of gold) or multiple amounts of property (e.g., two thousand dollars ($2,000.00). In other examples, the resource can be a computational resource such as processor cycles, memory space, etc.

The computing system can access organizational data associated with the entity. The organizational data can include information associated with one or more risk factors of the entity and/or one or more previous resource allocations of the entity. The organizational data can include a plurality of organizational records respectively associated with one or more entities (e.g., one or more organizations or employees) that are associated with the organization. The one or more risk factors can include an amount of the resource that is requested by the entity, an amount of collateral that is available to the entity that requested the resource, and/or an annual income associated with the entity. Further, the one or more previous resource allocations can include any resource allocations between the entity and the organization. Further, the one or more previous resource allocations can be associated with the entity receiving (e.g., borrowing funds or receiving an advance payment of funds that will be due to an organization or employee for completed work for the organization) some amount of resources from the organization, providing (e.g., paying) resources to the organization or an external organization (e.g., a bank) associated with the organization.

The computing system can determine a risk score associated with provisioning the resource to the entity. The risk score can be based at least in part on performance of one or more risk evaluation operations on the organizational data. The one or more risk factors can be respectively associated with one or more risk factor values that can be used to determine the risk score associated with a particular entity. Further, the risk score can be based at least in part on performance of one or more risk evaluation operations on the organizational data including the one or more risk factors of the entity.

In some embodiments, the risk score can be based at least in part on a sum total of the one or more risk factor values. Further, the risk score associated with high risk can be associated with a sum total of the one or more risk factor values that is high. A risk score associated with low risk can be associated with a sum total of the one or more risk factor values that is low. For example, the risk score associated with the highest risk can have a total value of one hundred (100), the risk score associated with the lowest risk can have a total value of zero (0), and the risk scores associated with intermediate levels of risk can have a total value between one (1) and ninety-nine (99).

A risk factor associated with an amount of collateral that is available to the entity can have a corresponding risk factor value that is inversely related and/or inversely proportional to the risk score. For example, an entity with a large amount of available collateral can have a low risk factor value to indicate that an entity with a greater amount of collateral presents a lower risk score.

In some embodiments, the one or more risk factors can be weighted based at least in part on the identity of the entity. The one or more risk factor values respectively associated with the one or more risk factors can have different weights. The one or more risk factors that are more heavily weighted can have a greater impact on the risk score than the one or more risk factors that are less heavily weighted. For example, a risk factor associated with an amount of collateral available to the entity can be weighed more heavily than a risk factor associated with a number of times the entity has previously repaid resources (e.g., funds) that were provisioned to the entity.

The computing system can determine a resource provisioning amount based at least in part on the risk score. The resource provisioning amount can include an amount of the resource authorized to be provisioned to the entity. The computing system can determine the resource provisioning amount based at least in part on whether the risk score is below a risk threshold. For example, if the risk threshold is twenty percent (20%), then the resource provisioning amount can zero (0) if the risk score is greater than or equal to the threshold (e.g., a risk score of thirty percent (30%)). In some embodiments, if the risk score exceeds the risk threshold, the computing system can determine that the resource provisioning amount is zero (0) and that the entity will not receive any resources. In some embodiments, if an amount of the resource that was requested in the resource request data was specified and/or indicated (e.g., a request for five hundred dollars ($500.00)), the computing system can determine a resource provisioning amount that is constrained by the requested amount (e.g., a resource provisioning amount that is not greater than the requested amount). In some embodiments, if an amount of the resource that was requested in the resource request data was not specified and/or indicated, the computing system can determine a resource provisioning amount that is not constrained by the resource request data.

In some embodiments, if the risk score is below the risk threshold, the computing system can determine that the resource provisioning amount will be equal to the amount of the resource associated with the resource request data. For example, if the request for a resource included a request for five hundred dollars ($500.00) and the risk score is below the risk threshold, then the resource provisioning amount would be five hundred dollars ($500.00).

In some embodiments, the resource provisioning amount can be associated with some portion of the amount of the resource associated with the resource request data. For example, if the risk score is expressed as a percentage (e.g., fifty percent (50%)) and the amount of the resource associated with the resource request data is one-thousand dollars ($1,000.00) the resource provisioning amount can be five hundred dollars ($500.00).

In some embodiments, the relationship between the risk score and the amount of the resource that the organization is authorized to provision to the entity can be linear or non-linear. Further, the portion of the amount of the resource associated with the resource request data can diminish as the risk score increases.

For example, if the risk score is expressed as a percentage (e.g., thirty percent (30%)) and the amount of the resource associated with the resource request data is one thousand dollars ($1,000.00) the resource provisioning amount can be seven hundred dollars ($300.00). However, if the risk score is expressed as a percentage (e.g., sixty percent (60%)) and the amount of the resource associated with the resource request data is one thousand dollars ($1,000.00) the resource provisioning amount can be four hundred dollars ($400.00).

The computing system can generate output. The output can include data, information, and/or detectable output (e.g., visually detectable and/or aurally detectable). Further, the output can include one or more indications associated with the resource provisioning amount. For example, the user interface can include a graphical user interface that is displayed on a display component of the computing system and is configured to receive one or more inputs (e.g., one or more touch inputs) from the user. By way of further example, the user interface can include an auditory user interface that uses one or more microphones to receive verbal commands from the user.

The one or more indications can include a description of the amount of the resource the organization is authorized to provision the entity. For example, the one or more indications can include the textual indication “YOU ARE AUTHORIZED TO RECEIVE $1,000” which notifies the entity of the amount of funds the entity is authorized to receive from the organization and/or a resource provisioning organization associated with the organization.

The one or more risk evaluation operations can include determining an amount of the resource that was previously remitted to or by the entity over a predetermined amount of time. For example, the computing system can access organizational data that includes information associated with the amount of the resource (e.g., money earned by an organization or employee) that was remitted to the entity (e.g., an organization or employee of the organization) during the time that the entity was employed by the organization.

Further, the one or more risk evaluation operations can include determining that the risk score is inversely related and/or inversely proportional to the amount of the resource that was previously remitted to or by the entity. The computing system can determine that the risk score of an organization or employee to or on behalf of whom ten thousand dollars ($10,000.00) was remitted in the past six (6) months is greater than the risk score of another organization or employee (e.g., another employee with the same position and income within the organization) to whom no money was remitted in the past six (6) months. If no resources were previously remitted to or by the entity, the risk factor associated with the amount of the resource that was previously remitted to or by the entity can be determined to have no effect on the risk score or have the effect of increasing the risk score.

The one or more risk evaluation operations can include determining an amount of the resource that was previously repaid by the entity over a predetermined amount of time. For example, the computing system can access organizational data that includes information associated with the amount of the resource (e.g., money earned by an employee) that was previously repaid by the entity (e.g., an organization or employee of the organization) during the time that the entity was employed by the organization.

Further, the one or more risk evaluation operations can include determining that the risk score is inversely related and/or inversely proportional to the amount of the resource that was previously repaid by the entity. The computing system can determine that the risk score of an external organization that previously repaid one hundred thousand dollars ($100,000.00) to the organization over the duration of the external organization's relationship with the organization is less than the risk score of another external organization that previously repaid twenty thousand dollars ($20,000.00) to the organization over the duration of the external organization's relationship with the organization. If the entity did not repay any money to the organization, the risk factor associated with the amount of the resource that was previously repaid by the entity can be determined to have no effect on the risk score or have the effect of increasing the risk score.

The one or more risk evaluation operations can include determining a number of contractors associated with the request. For example, the computing system can access organizational data and/or resource request data that includes information associated with the number of contractors that are included as part of the entity.

Further, the one or more risk evaluation operations can include determining that the risk score is inversely related and/or inversely proportional to the number of contractors associated with the request. For example, the computing system can determine that the risk score of provisioning an entity comprising a group of ten (10) contractors is greater than the risk score of provisioning an entity comprising a group of four (4) contractors.

The computing system can access the organizational data including information associated with one or more resource allocations between the entity and one or more third-party organizations. The one or more third-party organizations can include any organization that is not part of the organization that employs or contracts the entity. Further, the one or more third-party organizations can include any organization that is capable of providing resources to the entity. For example, the one or more third-party organizations can include a financial institution (e.g., a bank) and/or some other third-party organization that is able to provide resources to the entity.

Further, the computing system can determine the risk score based at least in part on the one or more resource allocations between the entity and the one or more third-party organizations. For example, the computing system can access organizational data that includes information associated with a credit history of the entity. The credit history of the entity can include information associated with financial resource allocations of the entity that can be used in the determination of the risk score of the entity. For example, an entity with a credit history that includes a consistent pattern of non-payment of debts can be associated with a higher risk score.

The computing system can determine, based at least in part on the resource request data, a location associated with the entity. For example, the resource request data can include information associated with a geographic location from which the request for the resource originated and/or a location associated with the computing device that generated the resource request data. In some embodiments, the location can include an Internet Protocol (IP) address associated with the entity.

Further, the computing system can determine an identity of the entity based at least in part on the location. For example, the computing system can access a look-up table including a set of entity identities and corresponding locations. The computing system can determine the identity of the entity by matching the location to the corresponding entity that is listed in the look-up table. The computing system can then determine the risk score associated with provisioning the resource to the entity based at least in part on the identity and/or location of the entity.

The computing system can receive one or more inputs via a user interface. The user interface can include a graphical user interface that is configured to display one or more interface elements associated with at least the resource request data and/or the organizational data and/or an aural user interface that is configured to generate audio output and/or recognize one or more aural inputs (e.g., spoken instructions and/or spoken commands). For example, the computing system can generate a graphical user interface that is displayed on a display device (e.g., a monitor) of the computing system. The graphical user interface can include interface elements that can be configured to receive input associated with the resource request data. For example, the one or more inputs can include an amount of the resource that is requested by the entity (e.g., an organization or employee of an organization). In some embodiments, the one or more inputs can be provided by the entity and/or some other individual or group that is not the entity.

Further, the computing system can generate the resource request data based at least in part on the one or more inputs. For example, the computing system can generate resource request data that includes an amount of the resource requested by the entity via the one or more inputs.

The one or more interface elements can include an identifier associated with the entity, an identifier associated with the organization, and/or an amount of the resource. For example, the one or more interface elements can be configured to receive one or more touch inputs. Further, the one or more interface elements can include an indication that a field of the interface element can receive a name of the entity (e.g., the name of an organization or employee), a name of an organization, and/or an amount of the resource that the entity is requesting.

In some embodiments, the one or more risk factors can include an amount of funds remitted over one or more previous withdrawals, a number of contractors associated with the entity, a payment history of the entity, and/or an Internet address associated with the entity. The amount of funds remitted over one or more previous withdrawals can include a monetary value (e.g., a dollar amount) of funds remitted to an entity. A greater amount of funds remitted to an entity can be associated with a lower risk score.

The number of contractors associated with the entity. The number of contractors associated with the entity can be inversely related and/or inversely proportional to the risk score. A greater number of contractors can be associated with a lower risk score.

The payment history of the entity can include a number of times the entity has paid outstanding debts and/or an amount of funds that the entity has provided to the organization. For example, the payment history of an organization or employee can include the organization or employee's debt level over time and the amount of funds that the organization or employee has provided to the organization in the past.

The Internet address associated with the entity can be used to determine whether the entity is associated with a high risk score, a low risk score, or one or more intermediate risk scores that are less than the high risk score and greater than the low risk score. For example, entities from a particular set of Internet addresses can be associated with a black list of entities that have a high risk score. The one or more entities that are associated with a high risk score can be assigned a corresponding risk score value or a default high risk score value (e.g., a risk score value that will result in a resource provisioning amount of zero (0) units of whatever resource is being requested.

In some embodiments, the one or more previous resource allocations can include the entity borrowing funds from the organization. For example, the one or more previous resource allocations can include an entity (e.g., an organization or employee of the organization) borrowing one thousand dollars ($1,000.00) from the organization. Further, the one or more previous resource allocations can include information associated with the time and date when the funds were borrowed.

In some embodiments, the resource provisioning amount can be inversely related and/or inversely proportional to the risk score. For example, a high risk score can be related to a resource provisioning amount that is low and a low risk score can be related to a resource provisioning amount that is high. In some embodiments, the resource provisioning amount can be linearly related to the risk score. For example, a ten percent (10%) increase in the risk score can result in a ten percent (10%) decrease in the resource provisioning amount; and a twenty percent (20%) increase in the risk score can result in a twenty percent (20%) decrease in the resource provisioning amount. In some embodiments, the resource provisioning amount can have a non-linear relationship with the risk score. For example, a ten percent (10%) increase in the risk score can result in a twenty percent (20%) decrease in the resource provisioning amount; and a twenty percent (20%) increase in the risk score can result in a fifty percent (50%) decrease in the resource provisioning amount.

In some embodiments, the one or more indications can include one or more scores (e.g., numeric scores) respectively associated with the risk score, one or more letter grades associated with the risk score, and/or one or more probabilities of repayment associated with the risk score. Further, the one or more indications can be generated on a display device of the computing system and/or via an audio output device of the computing system.

The one or more scores can be associated with the risk score. A high score can be associated with a risk score that is high and a low score can be associated with a risk score that is low. For example, a score of one hundred (100) can be associated with the highest risk score, a score of zero (0) can be associated with the lowest risk score, and scores between one (1) to ninety-nine (99) can be associated with intermediate levels of risk score.

The one or more letter grades can include an A grade associated with the risk score that is lowest and an F grade associated with the risk score that is highest. Intermediate letter grades of B, C, and D can be respectively associated with successively higher risk scores.

The one or more probabilities of repayment (e.g., one or more probabilities of the entity repaying a full or partial amount of the resource that was allocated) can be inversely related and/or inversely proportional to the risk score. For example, a high probability of repayment can be associated with a low risk score and a low probability of repayment can be associated with a high risk score.

In some embodiments, the one or more previous resource allocations can be between the entity and another entity that is not associated with the organization. For example, the one or more previous resource allocations can include one or more resource allocations between an entity (e.g., an organization or employee) of the organization and one or more businesses that provide goods and services to the entity. Further, the one or more previous resource allocations can include one or more resource allocations between an entity (e.g., organization or employee of the organization and one or more financial institutions that lend money to the organization or employee).

In some embodiments, the request can be associated with a request for disbursement of funds to the entity on behalf of the organization. For example, the request can include a request by an organization or employee of the organization for the organization to authorize a bank to pay the employee a portion of the employee's earned pay before a scheduled payment period.

In some embodiments, the entity can include an organization or employee of the organization or an employee of a third-party organization. For example, the entity can be an employee that works for the organization directly. Further, the entity can be the employee of a third-party that the organization is associated with (e.g., a third-party individual or group that the organization transacts business with). Further, the entity can include a group of individuals. For example, the entity can include a group of individuals that does work on behalf of the organization and/or that is contracted by the organization to do work for the organization without being an employee of the organization (e.g., one or more contractors)

In some embodiments, the one or more previous resource allocations can be between the entity and the organization. The one or more previous resource allocations can include one or more previous resource allocations in which the entity borrowed some amount of the resource from the organization and/or one or more previous resource allocations in which the entity was provided, by a third-party (e.g., a financial institution including a bank) with some amount of the resource based at least in part on authorization provided by the organization to the third-party. For example, the one or more previous resource allocations can include the entity (e.g., an organization or employee of the organization) requesting an advance payment of one (1) week's worth of their earned income ahead of the scheduled payment date that will occur in one week.

The disclosed technology can include a computing system and/or computing device that is configured to perform various operations associated with the generation and/or implementation of one or more security policies. In some embodiments, the user computing system can be associated with various computing systems and/or devices that use, send, receive, and/or generate information and/or data associated with the generation and/or implementation of one or more security policies. Furthermore, the user computing system can process, generate, modify, and/or access (e.g., send and/or receive) data and/or information including data and/or information associated with one or more rules, one or more policies, organizational data, and/or one or more organizational records.

In some implementations, the disclosed computing system can be operated from a server computing system that may be accessed by a user via one or more computing devices that are connected to the server computing system. Further, the disclosed computing system can be configured to access organizational records that may be stored locally or at remote locations that are accessible via a communications network (e.g., a Local Area Network (LAN) and/or the Internet).

The computing device can include specialized hardware and/or software that enable the performance of one or more operations specific to the disclosed technology. The user computing system can include one or more application specific integrated circuits that are configured to perform operations associated with the generation and/or implementation of one or more security policies.

The systems, methods, devices, apparatuses, and tangible non-transitory computer-readable media in the disclosed technology can provide a variety of technical effects and benefits including an improvement in the estimation of risk and determination of resource provisioning amounts. In particular, the disclosed technology may assist a user (e.g. an administrator of a security policy) in performing a technical task by means of a continued and/or guided human-machine interaction process in which the user can interact with a user interface that can be used to receive requests for resources . Furthermore, the disclosed technology may also provide benefits including improvements in computing resource usage efficiency, security, and ease of use.

The disclosed technology can provide a variety of technical effects and benefits with respect to the efficiency of computing resource usage by reducing the number of different queries that need to be made to authorize the provisioning of an amount of resources to an entity. By using organizational data as a basis for estimating the risk associated with an entity, the disclosed technology can access a centralized source of information that can be used to develop a more complete picture of the entity's risk score based on various risk factors and previous resource allocations. In this way, a piece-meal approach in which different sources of information are individually accessed can be reduced and/or avoided, thereby reducing the amount of burdensome work and resulting in more accurate estimations of risk.

Furthermore, the disclosed technology can be used to provide more coherent and consistent estimations of risk and resource provisioning amounts.

As such, the disclosed technology may assist a user in more effectively performing a variety of resource provisioning tasks by providing the specific benefits of improved ease of use; and reduction of risk. Further, any of the specific benefits provided to users can be used to improve the effectiveness of a wide variety of devices and services including any devices or services that rely on the disclosed technology. Accordingly, the improvements offered by the disclosed technology can result in tangible benefits to a variety of applications, devices, and/or systems including mechanical, electronic, and computing systems associated with the estimation of risk and determination of resource provisioning amounts.

With reference to the Figures, example embodiments of the present disclosure will be discussed in further detail.

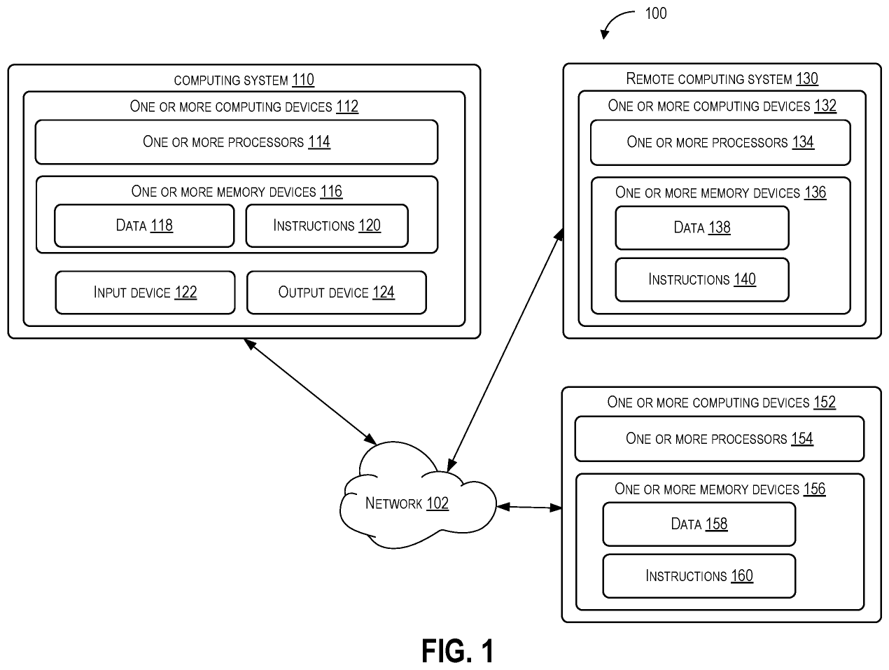

FIG. 1 depicts a block diagram of an example environment including a computing system that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the Internet. Further, the network 102 can include any number of wired or wireless connections and/or links that can be used to communicate with one or more systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems and/or one or more computing devices. Further, the computing system 110 may be connected (e.g., networked) to one or more computing systems and/or one or more computing devices via the network 102. The computing system 110 may operate in various different configurations including as a server or a client machine in client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes the one or more computing devices 112. The one or more computing devices 112 can include any type of computing device. For example, the one or more computing devices 112 can include a personal computing device (e.g., a desktop computing device), a mobile computing device (e.g., a smartphone or tablet), a wearable computing device (e.g., a smartwatch), an embedded computing device, a web appliance, a server, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can be include any processing device (e.g., a processor core, a microprocessor, an ASIC, a FPGA, a controller, or a microcontroller) and can include one processor or a plurality of processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random access memory (RAM), read only memory (ROM), EEPROM, EPROM, one or more flash memory devices, one or more magnetic storage devices (e.g., one or more hard disk drives).

The one or more processors 114 can be configured to execute one or more instructions to perform the operations described herein including one or more operations associated with resource provisioning based on risk scores. For example, the one or more processors can be configured to execute one or more instructions associated with performing operations including accessing resource request data, accessing organizational data, determining a risk score based on performance of risk evaluation operations, determining a resource provisioning amount based on the risk score, and/or generating an output including indications associated with the resource provisioning amount. Further, the one or more memory devices 116 can store the data 118 and/or the instructions 120, which can be executed by the one or more processors 114 to cause the one or more computing devices 112 to perform one or more operations.

The data 118 can include resource request data (e.g., data associated with a request for one or more resources) and/or organizational data (e.g., organizational data including information associated with one or more risk factors), which are described herein. Further, the instructions 120 can include one or more instructions to use data including the data 118 to perform the one or more operations described herein. In some embodiments, the one or more memory devices 116 can be used to store one or more applications that can be operated by the one or more processors 114. The data 118, the instructions 120, and/or the one or more applications can be associated with an organization. Further, the computing system 110 may be associated with an organization and may be configured to manage and/or administer the one or more applications. For example, the computing system 110 can perform one or more operations associated with requests for resources (e.g., funds) from an entity (e.g., a user) via the computing system 110 and/or a computing system that is remote from the computing system 110 (e.g., the remote computing system 130).

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a user interface (e.g., a graphical user interface) via a display device that can include a touch screen layer that is configured to detect one or more user inputs.

The remote computing system 130 includes the one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110.

Further, the remote computing system 130 can communicate with one or more devices and/or one or more systems via the network 102.

In some embodiments, the remote computing system 130 can include one or more applications (e.g., computing/computer software applications) that can be stored and/or executed by the remote computing system 130. Further, the one or more applications can include one or more organizational applications that may be accessed from the computing system 110 and are at least partly operated from the remote computing system 130. Further, the data 138 can include one or more portions of the resource request data and/or the organizational data.

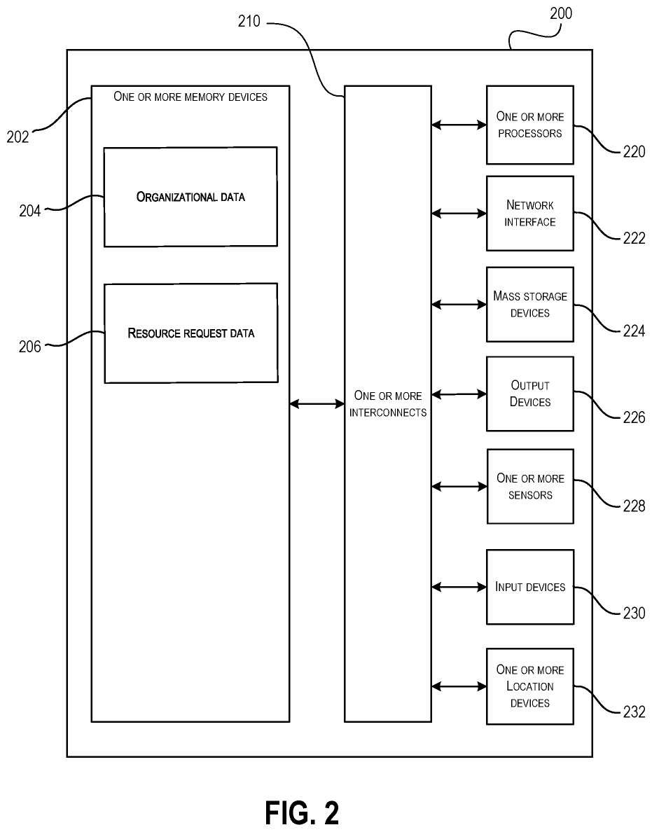

FIG. 2 depicts a block diagram of an example computing device according to example embodiments of the present disclosure. A computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, organizational data 204, resource request data 206, one or more interconnects 210, one or more processors 220, a network interface 222, one or more mass storage devices 224, one or more output devices 226, one or more sensors 228, one or more input devices 230, and/or the location device 232.

The one or more memory devices 202 can store information and/or data (e.g., the organizational data 204 and/or the resource request data 206). Further, the one or more memory devices 202 can include one or more non-transitory computer-readable storage media, including RAM, ROM, EEPROM, EPROM, flash memory devices, magnetic disks, and combinations thereof. The information and/or data stored by the one or more memory devices 202 can be executed by the one or more processors 220 to cause the computing device 200 to perform operations including operations associated with accessing resource request data, accessing organizational data, determining a risk score based on performance of risk evaluation operations, determining a resource provisioning amount based on the risk score, and/or generating an output including indications associated with the resource provisioning amount.

The organizational data 204 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the organizational data 204 can include information associated with one or more organizational records. In some embodiments, the organizational data 204 can be received from one or more computing systems (e.g., the remote computing system 130 depicted in FIG. 1) which can include one or more computing systems that are remote (e.g., in another room, building, part of town, city, or nation) from the computing device 200.

The resource request data 206 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the resource request data 206 can include information associated with a request for resources from an entity (e.g., a financial institution) associated with an organization. In some embodiments, the resource request data 206 can be received from one or more computing systems (e.g., the remote computing system 130 depicted in FIG. 1) which can include one or more computing systems that are remote from the computing device 200.

The one or more interconnects 210 can include one or more interconnects or buses that can be used to send and/or receive one or more signals (e.g., electronic signals) and/or data (e.g., the organizational data 204 and/or the resource request data 206) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the location device 232. The one or more interconnects 210 can be arranged or configured in different ways. For example, the one or more interconnects 210 can be configured as parallel or serial connections. Further the one or more interconnects 210 can include: one or more internal buses that are used to connect the internal components of the computing device 200; and one or more external buses used to connect the internal components of the computing device 200 to one or more external devices. By way of example, the one or more interconnects 210 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the organizational data 204 and/or the resource request data 206. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the Internet). For example, the network interface 222 can allow the computing device 200 to communicate with the computing system 110 via the network 102. By way of further example, the network interface 222 can support encrypted communications that allow the computing device 200 to send encrypted data to the computing system 110 and/or the remote computing system 130 via the network 102.

The one or more mass storage devices 224 (e.g., a hard disk drive and/or a solid state drive) can be used to store data including the organizational data 204 and/or the resource request data 206. The one or more output devices 226 can include one or more display devices (e.g., LCD display, OLED display, Mini-LED display, microLED display, plasma display, and/or CRT display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of a security policy that regulates access to the computing device 200. For example, the one or more sensors 228 can be used to authenticate the identity of a user based on an image of the user's face that is captured using the one or more sensors 228.

The one or more input devices 230 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200).

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications that are generated and/or implemented by the computing device 200, one or more other computing devices, and/or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The location device 232 can include one or more devices or circuitry for determining the position of the computing device 200. For example, the location device 232 can determine an actual and/or relative position of the computing device 200 by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or Wi-Fi hotspots, and/or beacons.

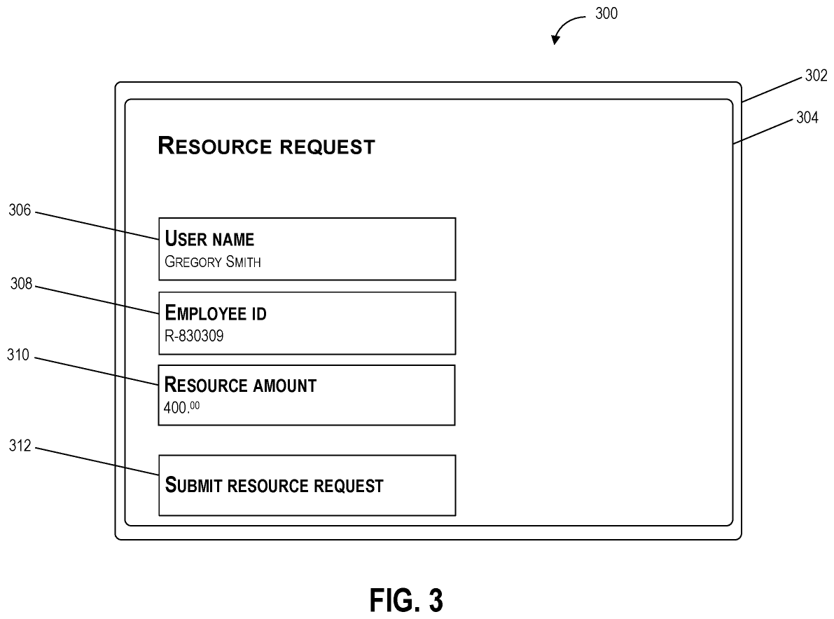

FIG. 3 depicts an example of a graphical user interface for resource provisioning based on risk scores according to example embodiments of the present disclosure. A computing device 300 can include one or more attributes and/or capabilities of the computing system 110, the remote computing system 130, the one or more computing devices 152, and/or the computing device 200. Furthermore, the computing device 300 can be configured to perform one or more operations and/or one or more actions that can be performed by the computing system 110, the remote computing system 130, the one or more computing devices 152, and/or the computing device 200.

As shown in FIG. 3, the computing device 300 includes a display component 302, a user interface 304, an interface element 306, an interface element 308, an interface element 310, and an interface element 312.

In this example, the computing device 300 is configured to generate output including a user interface 304 (e.g., a graphical user interface) that includes the interface element 306, the interface element 308, and the interface element 310 on the display component 302. The output of the computing device 300 can be used to generate resource request data that is associated with a request for a resource from an entity (e.g., an organization or employee associated with an organization). In this example, the resource being requested is funds from an organization for which the employee is employed. Further, the funds that are being requested are based on the pay that was earned by the employee for days that the employee worked. For example, if the employee earns two thousand dollars ($2,000.00) per week, the employee is paid every two (2) weeks, for five (5) days of work per week (four hundred ($400.00) per day), and the employee has one (1) day of work remaining until being paid, then the employee will have earned three thousand six hundred dollars ($3,600.00) at the time of the request for the resource.

The display component 302 can be configured to receive one or more inputs to cause the computing device 300 to perform one or more operations (e.g., operations associated with generating resource request data). For example, the display component 302 can be configured to receive one or more touch inputs from a user to indicate the selection by the user of an interface element to the user interface 304. In some embodiments, the computing device 300 can receive other types of input including audio input (e.g., a user speaking a command to select an interface element), an external input device (e.g., a mouse device or keyboard), or a gesture (e.g., a gesture recognized by a camera of the computing device 300). In some embodiments, the computing device 300 can be configured to receive one or more inputs from one or more other computing devices (e.g., a laptop computer, a desktop computer, and/or a smartphone) that communicate with the computing device 300.

The user interface 304 includes the interface element 306, interface element 308 and interface element 310 which are associated with receiving an input to generate resource request data. The interface element 306 indicates a user name associated with the user making the resource request. In this example, the interface element 306 is populated based at least in part on one or more inputs that were previously provided by the user to authenticate the identity of the user. For example, the interface element 306 can be based at least in part on a user identifier and password that were provided by the user “GREGORY SMITH” in order to access the resource request user interface. If a different user had provided different authentication information, then the interface element 306 would be populated with different information. For example, if a user “ALICE TWEED” had provided her unique combination of authentication information (e.g., Alice Tweed's user identifier and password) then the interface element 306 would be populated with the user name “ALICE TWEED” instead of the name “GREGORY SMITH” as indicated in the interface element 306.

The interface element 308 indicates an organization or employee identifier (e.g., “R-830309”) that uniquely identifies the organization or employee that is generating the resource request data. The organization or employee identifier in the interface element 308 is populated based at least in part on the one or more inputs that were previously provided by the user to authenticate the identity of the user.

The interface element 310 indicates an amount of a resource (e.g., funds) that is being requested by the organization or employee based at least in part on one or more user inputs. For example, a user touching the interface element 310 can cause a pop-up numeric keypad (e.g., a keypad with the numbers 0, 1, 2, 3, 4, 5, 6, 7, 8, 9, and 10) to be generated on the user interface 304. The user can then touch the numbers of the numeric keypad to determine the amount of the resource that is being requested. For example, the user can tap “4,” “0,” “0” to indicate “$400” as shown in the resource amount indicated in the interface element 310.

In some embodiments, the resource amount that can be entered in the interface element 310 can be constrained. The constraint on the resource amount can be a predetermined amount. For example, the resource amount indicated in the interface element 310 can be constrained to an amount that is no greater than one thousand dollars ($1,000.00), so that no organization or employee of the organization can request greater than that amount. In some embodiments, the resource amount can be constrained based at least in part on the identity of the organization or employee (e.g., the unique organization or employee id indicated in the interface element 308). In particular, the constraint on the resource amount can be based at least in part on the income that is associated with the organization or employee associated with the organization or employee id indicated in the interface element 308. For example, the resource amount can be constrained to an amount that is no greater than the weekly income of the organization or employee (e.g., two thousand dollars ($2,000.00)).

The interface element 312, which indicates “SUBMIT RESOURCE REQUEST” is a control that can be used to generate the resource request data associated with the resource amount indicated in the interface element 310. For example, a user touching the interface element 312 can cause the computing device 300 to generate resource request data associated with a request for four hundred dollars ($400.00) as indicated in the interface element 310. Further, the computing device 300 can perform one or more operations including accessing organizational data associated with the organization or employee indicated in the interface element 306 and performing one or more risk evaluation operations that are based at least in part on the organizational data. In some embodiments, the computing device 300 can send the resource request data to a remote computing device and/or a remote computing system that can use the resource request data to determine a resource provisioning amount.

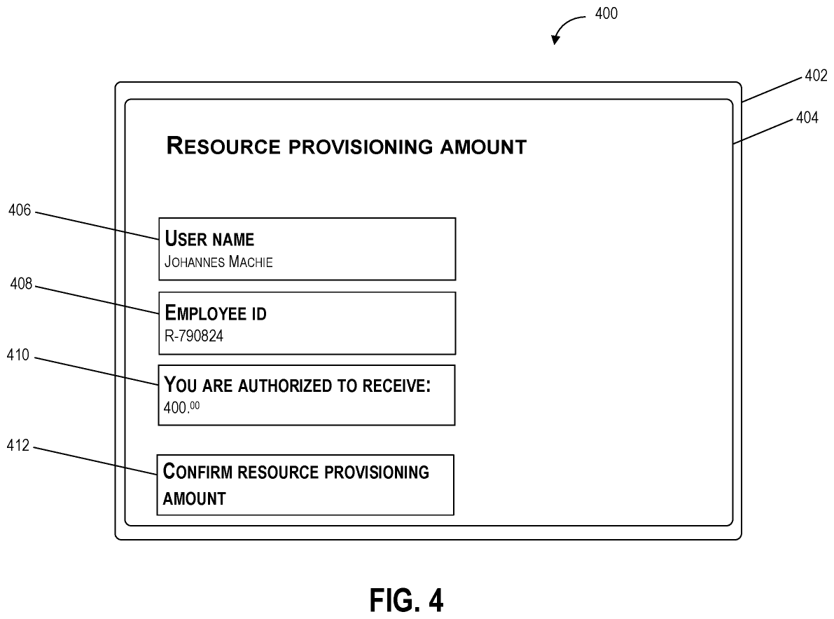

FIG. 4 depicts an example of output associated with resource provisioning based on risk scores according to example embodiments of the present disclosure. A computing device 400 can include one or more attributes and/or capabilities of the computing system 110, the remote computing system 130, the one or more computing devices 152, and/or the computing device 200. Furthermore, the computing device 400 can be configured to perform one or more operations and/or one or more actions that can be performed by the computing system 110, the remote computing system 130, the one or more computing devices 152, and/or the computing device 200.

As shown in FIG. 4, the computing device 400 includes a display component 402, a user interface 404, an interface element 406, an interface element 408, an interface element 410, and an interface element 412.

In this example, the computing device 400 is configured to generate output including a user interface 404 (e.g., a graphical user interface) that includes the interface element 406, the interface element 408, the interface element 410, and the interface element 412 on the display component 402. The output of the computing device 400 can include one or more indications (e.g., textual indications) associated with a resource provisioning amount for an entity (e.g., an organization or employee associated with an organization). In this example, the resource provisioning amount the organization is authorized to provide to the entity is four hundred dollars ($400.00) as indicated in the interface element 410.

The display component 402 can be configured to receive one or more inputs to cause the computing device 400 to perform one or more operations (e.g., operations associated with generating resource request data). For example, the display component 402 can be configured to receive one or more touch inputs from a user to indicate the selection by the user of an interface element to the user interface 404. In some embodiments, the computing device 400 can receive other types of input including audio input (e.g., a user speaking a command to select an interface element), an external input device (e.g., a mouse device or keyboard), or a gesture (e.g., a gesture recognized by a camera of the computing device 400). In some embodiments, the computing device 400 can be configured to receive one or more inputs from one or more other computing devices (e.g., a laptop computer, a desktop computer, and/or a smartphone) that communicate with the computing device 400.

The user interface 404 includes the interface element 406, interface element 408 and interface element 410 which are associated with receiving an input to receive a resource provisioning amount that was authorized by an organization. The interface element 406 indicates a user name associated with the user making the resource request. In this example, the interface element 406 is populated based at least in part on one or more inputs that were previously provided by the user to authenticate the identity of the user. For example, the interface element 406 can be based at least in part on a user identifier and password that were provided by the user “JOHANNES MACHIE” in order to access the resource request user interface. If a different user had provided different authentication information, then the interface element 406 would be populated with different information. For example, if a user “MICHELLE DENISOVA” had provided her unique combination of authentication information (e.g., Alice Tweed's user identifier and password) then the interface element 406 would be populated with the user name “MICHELLE DENISOVA” instead of the name “JOHANNES MACHIE” as indicated in the interface element 406.

The interface element 408 indicates an organization or employee identifier (e.g., “R-790824”) that uniquely identifies the organization or employee that is generating the resource request data. The organization or employee identifier in the interface element 408 is populated based at least in part on the one or more inputs that were previously provided by the user to authenticate the identity of the user and/or that are associated with the resource request data that was used to request the resource from the organization.

The interface element 410 indicates a resource provisioning amount (e.g., funds) that the entity is authorized to receive from the organization. For example, the interface element 410 can indicate an amount in some currency (e.g., Euros or Dollars) that the organization is authorized to provide to the entity.

In some embodiments, the resource provisioning amount indicated in the interface element 410 can be constrained. The constraint on the resource provisioning amount can be a predetermined amount. For example, the resource provisioning amount indicated in the interface element 410 can be constrained to an amount that is no greater than one thousand dollars ($1,000.00), so that no organization or employee of the organization can receive more than that amount. In some embodiments, the resource amount can be constrained based at least in part on the identity of the organization or employee (e.g., the unique organization or employee id indicated in the interface element 408). In particular, the constraint on the resource amount can be based at least in part on the income that is associated with the organization or employee associated with the organization or employee id indicated in the interface element 408. For example, the resource amount can be constrained to an amount that is no greater than the weekly income of the organization or employee (e.g., two thousand dollars ($2,000.00)). In some embodiments, the resource provisioning amount can be constrained based at least in part on the position of the entity within the organization. A higher position within the organization's hierarchy can be associated with a higher threshold for the resource provisioning amount that the organization is authorized to provide to the entity.

The interface element 412, which indicates “CONFIRM RESOURCE PROVISIONING AMOUNT” is a control that can be used to confirm that the user would like to receive the resource provisioning amount indicated in the interface element 410. For example, a user touching the interface element 412 can cause the computing device 400 to send a message confirming that the user will receive the resource provisioning amount of four hundred dollars ($400.00) as indicated in the interface element 410.

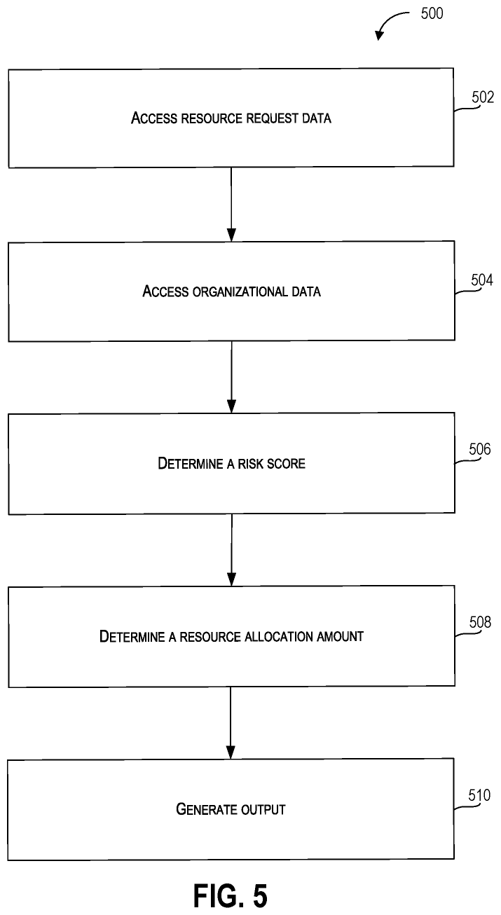

FIG. 5 depicts a flow diagram of allocating resources based on risk scores according to example embodiments of the present disclosure. One or more portions of the method 500 can be executed and/or implemented on one or more computing devices or computing systems including, for example, the computing system 110, the remote computing system 130, the one or more computing devices 152, and/or the computing device 200. Further, one or more portions of the method 500 can be executed or implemented as an algorithm on the hardware devices or systems disclosed herein. FIG. 5 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 502, the method 500 can include accessing resource request data that includes information associated with a request for a resource from an entity associated with an organization. For example, the computing system 110 can access resource request data that was sent to the computing system 110 from the one or more computing devices 152 which include a smartphone that is running a software application that allows an organization or employee of an organization to request funds from the organization or be transmitted or allocated on behalf of the organization. Further, the resource request data can include a request for five hundred dollars ($500.00).

At 504, the method 500 can include accessing organizational data associated with the entity. The organizational data can include information associated with one or more risk factors of the entity and one or more previous resource allocations of the entity. For example, the computing system 110 can access organizational data that includes information associated with an amount of collateral that is available to the organization or employee associated with the resource request data as well as a number of previous resource allocations (e.g., requests for resources) that the organization or employee previously completed.

At 506, the method 500 can include determining a risk score based at least in part on performance of one or more risk evaluation operations on the organizational data. The risk score can include a risk score associated with provisioning the resource to the entity. For example, the computing system 110 can be configured to perform one or more risk evaluation operations including determining the risk score based at least in part on an amount of collateral available to the organization or employee relative to a low risk collateral amount.

At 508, the method 500 can include determining a resource provisioning amount based at least in part on the risk score. The resource provisioning amount can include an amount of the resource authorized to be provisioned to the entity. For example, the computing system 110 can determine that the resource provisioning amount is equal to the amount of the resource that was requested in the resource request data (e.g., the five hundred dollars ($500.00) indicated in 502) if the risk score is below a risk score threshold.

At 510, the method 500 can include generating output that can include one or more indications associated with the resource provisioning amount. For example, the computing system 110 can generate one or more visual indications including text indicating that the organization or employee can receive an amount of money equivalent to the resource provisioning amount (e.g., the five hundred dollars ($500.00) indicated in 502 and/or 508).

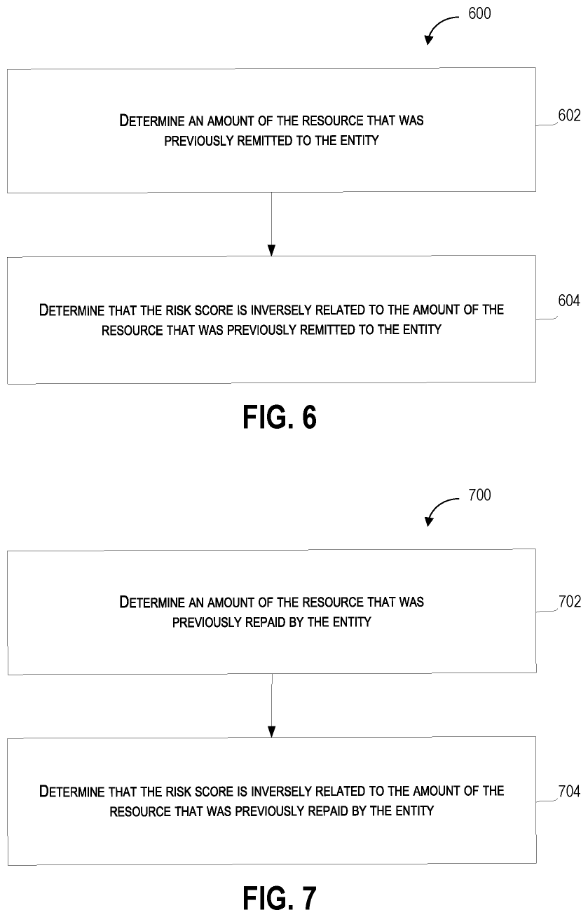

FIG. 6 depicts a flow diagram of allocating resources based on risk scores according to example embodiments of the present disclosure. One or more portions of the method 600 can be executed and/or implemented on one or more computing devices or computing systems including, for example, the computing system 110, the remote computing system 130, the one or more computing devices 152, and/or the computing device 200. Further, one or more portions of the method 600 can be executed or implemented as an algorithm on the hardware devices or systems disclosed herein. FIG. 6 depicts steps performed in a particular order for purposes of illustration and discussion. In some embodiments, one or more portions of the method 600 can be performed as part of the method 500 that is depicted in FIG. 5. Further, one or more portions of the method 600 can be associated with performing the one or more risk evaluation operations described in the method 500. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include determining an amount of the resource that was previously remitted to or by the entity over a predetermined amount of time. For example, the computing system 110 can access the organizational data that includes information associated with the amount of the resource (e.g., funds) that was remitted to an organization or employee of the organization in the past year.

At 604, the method 600 can include determining that the risk score is associated with the amount of the resource that was previously remitted to or by the entity over the predetermined time period. The computing system 110 can determine that the risk score is inversely related and/or inversely proportional to the amount of the resource that was remitted to an organization or employee of the organization (e.g., a greater amount of the resource being remitted is related to a lower risk score) in the past year. For example, an organization or employee to whom fifteen thousand dollars ($15,000.00) was remitted over the course of twenty (20) resource allocations in the past year can have a risk score that is lower than an organization or employee to whom fifty dollars ($50.00) was remitted in one resource allocation in the past year.

FIG. 7 depicts a flow diagram of allocating resources based on risk scores according to example embodiments of the present disclosure. One or more portions of the method 700 can be executed and/or implemented on one or more computing devices or computing systems including, for example, the computing system 110, the remote computing system 130, the one or more computing devices 152, and/or the computing device 200. Further, one or more portions of the method 700 can be executed or implemented as an algorithm on the hardware devices or systems disclosed herein. FIG. 7 depicts steps performed in a particular order for purposes of illustration and discussion. In some embodiments, one or more portions of the method 700 can be performed as part of the method 500 that is depicted in FIG. 5. Further, one or more portions of the method 700 can be associated with performing the one or more risk evaluation operations described in the method 500. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining an amount of the resource that was previously repaid by the entity over a predetermined amount of time. For example, the computing system 110 can access the organizational data that includes information associated with the amount of the resource (e.g., funds) that was repaid by the organization or employee of the organization in the past year.

At 704, the method 700 can include determining that the risk score is associated with the amount of the resource that was previously repaid by the entity. The computing system 110 can determine that the risk score is inversely related and/or inversely proportional to the amount of the resource that was repaid by the organization or employee to the organization (e.g., a greater amount of the resource being repaid by the organization or employee is related to a lower risk score) in the past year. For example, an organization or employee that paid back ten thousand dollars ($10,000.00) in the past year can have a risk score that is lower than an organization or employee that paid back one hundred dollars ($100.00) in the past year.

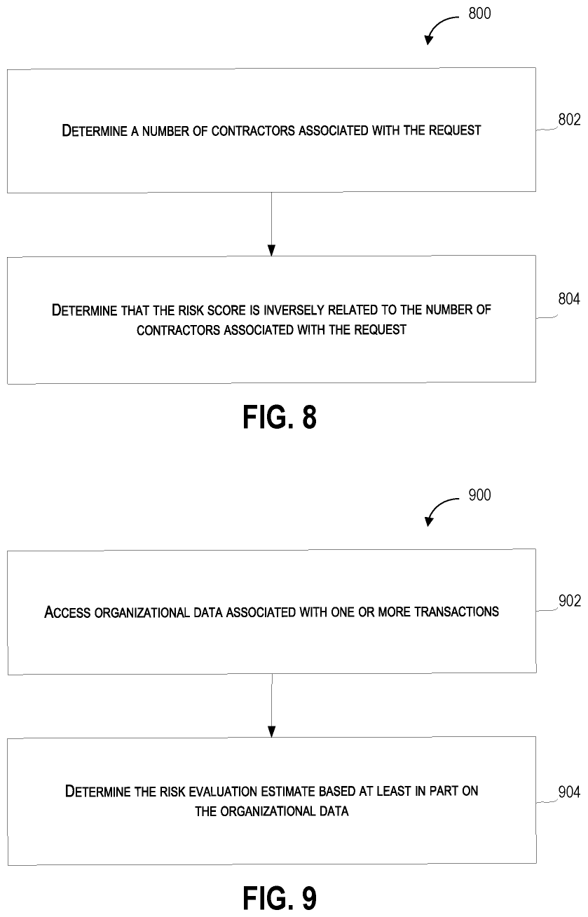

FIG. 8 depicts a flow diagram of allocating resources based on risk scores according to example embodiments of the present disclosure. One or more portions of the method 800 can be executed and/or implemented on one or more computing devices or computing systems including, for example, the computing system 110, the remote computing system 130, the one or more computing devices 152, and/or the computing device 200. Further, one or more portions of the method 800 can be executed or implemented as an algorithm on the hardware devices or systems disclosed herein. FIG. 8 depicts steps performed in a particular order for purposes of illustration and discussion. In some embodiments, one or more portions of the method 800 can be performed as part of the method 500 that is depicted in FIG. 5. Further, one or more portions of the method 800 can be associated with performing the one or more risk evaluation operations described in the method 500. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include determining a number of contractors associated with the request. For example, the computing system 110 can access the organizational data that includes information associated with the number of contractors that are part of the entity.

At 804, the method 800 can include determining the risk score based at least in part on the number of contractors associated with the request. The computing system 110 can determine that the risk score is positively correlated with the number of contractors that are part of the entity (e.g., a greater number of contractors will result in greater risk score). For example, an entity that has five (5) contractors can have a risk score that is lower than an entity that has thirty (30) contractors.

FIG. 9 depicts a flow diagram of allocating resources based on risk scores according to example embodiments of the present disclosure. One or more portions of the method 900 can be executed and/or implemented on one or more computing devices or computing systems including, for example, the computing system 110, the remote computing system 130, the one or more computing devices 152, and/or the computing device 200. Further, one or more portions of the method 900 can be executed or implemented as an algorithm on the hardware devices or systems disclosed herein. FIG. 9 depicts steps performed in a particular order for purposes of illustration and discussion. In some embodiments, one or more portions of the method 900 can be performed as part of the method 500 that is depicted in FIG. 5. Further, one or more portions of the method 900 can be associated with performing the one or more risk evaluation operations described in the method 500. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include accessing the organizational data including information associated with one or more resource allocations comprising the entity and not comprising the organization. For example, the computing system 110 can access organizational data that includes information associated with one or more resource allocations between the entity and a third-party money lender.

At 904, the method 900 can include determining the risk score based at least in part on the organizational data. For example, the one or more risk evaluation operations can be based at least in part on evaluation of the risk associated with the one or more resource allocations between the entity and a third-party money lender.

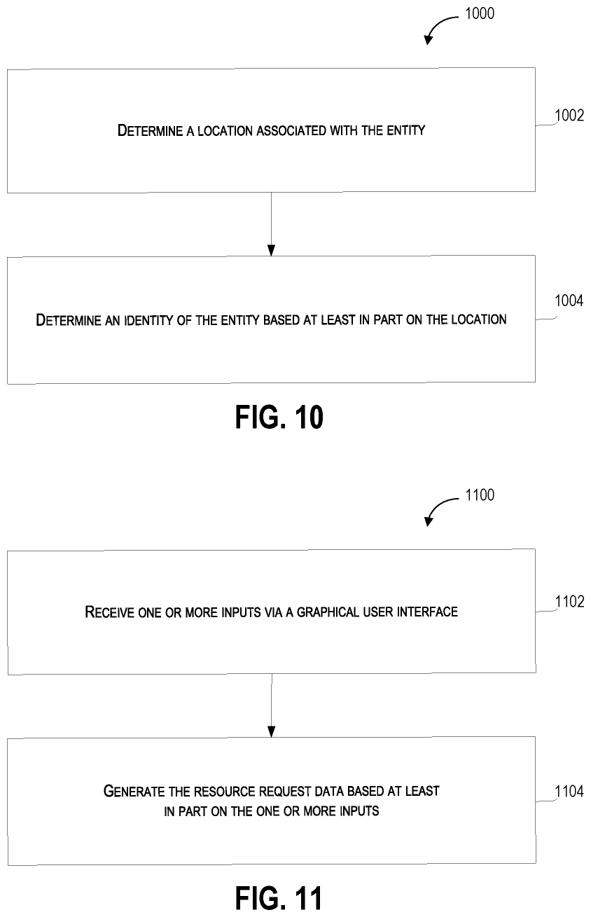

FIG. 10 depicts a flow diagram of allocating resources based on risk scores according to example embodiments of the present disclosure. One or more portions of the method 1000 can be executed and/or implemented on one or more computing devices or computing systems including, for example, the computing system 110, the remote computing system 130, the one or more computing devices 152, and/or the computing device 200. Further, one or more portions of the method 1000 can be executed or implemented as an algorithm on the hardware devices or systems disclosed herein. FIG. 10 depicts steps performed in a particular order for purposes of illustration and discussion. In some embodiments, one or more portions of the method 1000 can be performed as part of the method 500 that is depicted in FIG. 5. Further, one or more portions of the method 1000 can be associated with performing the one or more risk evaluation operations described in the method 500. Those of ordinary skill in the art, using the disclosures provided herein, will understand that various steps of any of the methods disclosed herein can be adapted, modified, rearranged, omitted, and/or expanded without deviating from the scope of the present disclosure.

At 1002, the method 1000 can include determining, based at least in part on the resource request data, a location associated with the entity. The location can include an Internet Protocol (IP) address associated with the entity. For example, the computing system 110 can access information included in the resource request data that indicates a geographic location or IP address associated with the location of the entity.

At 1004, the method 1000 can include determining the risk score based at least in part on the location associated with the entity. For example, the computing system 110 can access entity data that includes a list of entity identities and locations respectively associated with the entity identities. The identity of the entity can be determined by matching the location to the corresponding entity identity in the entity data. The risk score can then be determined based on the entity identity.

FIG. 11 depicts a flow diagram of allocating resources based on risk scores according to example embodiments of the present disclosure. One or more portions of the method 1100 can be executed and/or implemented on one or more computing devices or computing systems including, for example, the computing system 110, the remote computing system 130, the one or more computing devices 152, and/or the computing device 200. Further, one or more portions of the method 1100 can be executed or implemented as an algorithm on the hardware devices or systems disclosed herein. FIG. 11 depicts steps performed in a particular order for purposes of illustration and discussion. In some embodiments, one or more portions of the method 1100 can be performed as part of the method 500 that is depicted in FIG. 5. Those of ordinary skill in the art, using the disclosures provided herein, will understand that various steps of any of the methods disclosed herein can be adapted, modified, rearranged, omitted, and/or expanded without deviating from the scope of the present disclosure.

At 1102, the method 1100 can include receiving one or more inputs via a graphical user interface configured to display one or more interface elements associated with at least the entity. For example, the computing system 110 can generate a graphical user interface that is displayed on a display component of the computing system 110. The graphical user interface can include interface elements that can be configured to receive one or more inputs associated with the resource request data. For example, the one or more inputs can include an amount of the resource that is requested by the entity (e.g., an organization or employee of an organization).

At 1104, the method 1100 can include generating the resource request data based at least in part on the one or more inputs. For example, the computing system 110 can generate resource request data that includes the amount of the resource requested by the entity based at least in part on the one or more inputs including the amount of the resource that is indicated as being requested by the entity (e.g., an organization or employee of the organization).

Numerous details are set forth in the foregoing description. However, it will be apparent to one of ordinary skill in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “accessing,” “analyzing,” “determining,” “identifying,” “adjusting,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the appended claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for provisioning resources, the computing system comprising:
one or more processors; and
one or more non-transitory computer-readable media that store instructions that, when executed by the one or more processors, cause the computing system to perform operations, the operations comprising:
accessing resource request data comprising information associated with a request for a resource from an entity associated with an organization;
accessing organizational data associated with the entity, wherein the organizational data comprises information associated with one or more risk factors of the entity and one or more previous resource allocations of the entity, the one or more risk factors being weighted based at least in part on identity of the entity;
determining, based at least in part on the identity of the entity and performance of one or more risk evaluation operations on the organizational data, a risk score associated with provisioning the resource to the entity;
determining a resource provisioning amount based at least in part on whether the risk score is below a risk threshold, wherein the resource provisioning amount comprises an amount of the resource authorized to be provisioned to the entity when the risk score is below the risk threshold, and wherein the amount is determined based at least in part on a relationship between the risk score and the amount or a requested amount for the resource, the requested amount being in the resource request data; and
generating output comprising one or more indications associated with the resource provisioning amount.

2. The computing system of claim 1, wherein the one or more risk evaluation operations comprise:
determining an amount of the resource that was previously remitted to or by the entity over a predetermined amount of time; and
determining that the risk score is inversely related to the amount of the resource that was previously remitted to or by the entity.

3. The computing system of claim 1, wherein the one or more risk evaluation operations comprise:
determining an amount of the resource that was previously repaid by the entity over a predetermined amount of time; and
determining that the risk score is inversely related to the amount of the resource that was previously repaid by the entity.

4. The computing system of claim 1, wherein the one or more risk evaluation operations comprise:
determining a number of contractors associated with the request; and
determining that the risk score is inversely related to the number of contractors associated with the request.

5. The computing system of claim 1, wherein the one or more risk evaluation operations comprise:
accessing the organizational data comprising information associated with one or more resource allocations between the entity and one or more third-party organizations; and
determining the risk score based at least in part on the one or more resource allocations between the entity and the one or more third-party organizations.

6. The computing system of claim 1, wherein the one or more risk evaluation operations comprise:
determining, based at least in part on the resource request data, a location associated with the entity, wherein the location comprises an Internet Protocol (IP) address associated with the entity; and
determining the risk score based at least in part on the location associated with the entity.

7. The computing system of claim 6, wherein the one or more risk factors are weighted based at least in part on the location associated with the entity.

8. The computing system of claim 1, wherein the operations comprise:
receiving one or more inputs via a graphical user interface configured to display one or more interface elements associated with at least the resource request data; and
generating the resource request data based at least in part on the one or more inputs.

9. The computing system of claim 8, wherein the one or more interface elements comprise an identifier associated with the entity, an identifier associated with the organization, or an amount of the resource that is requested by the entity.

10. The computing system of claim 1, wherein the one or more risk factors comprise an amount of funds remitted over one or more previous withdrawals, a number of contractors associated with the entity, a payment history of the entity, or an Internet address associated with the entity.

11. The computing system of claim 1, wherein the one or more previous resource allocations comprise the entity borrowing funds from the organization.

12. The computing system of claim 1, wherein the resource provisioning amount is inversely related to the risk score.

13. The computing system of claim 1, wherein the one or more indications comprise one or more scores respectively associated with the risk score, one or more letter grades associated with the risk score, or one or more probabilities of repayment associated with the risk score.

14. The computing system of claim 13, wherein the one or more scores are associated with the risk score, the one or more letter grades comprise an A grade associated with the risk score that is lowest and an F grade associated with the risk score that is highest, and wherein the one or more probabilities of repayment are inversely related to the risk score.

15. A computer-implemented method of resource provisioning based on risk scores, the computer-implemented method comprising:
accessing, by a computing system comprising one or more processors, resource request data comprising information associated with a request for a resource from an entity associated with an organization;
accessing, by the computing system, organizational data associated with the entity, wherein the organizational data comprises information associated with one or more risk factors of the entity and one or more previous resource allocations of the entity, the one or more risk factors being weighted based at least in part on identity of the entity;
determining, by the computing system, based at least in part on the identity of the entity and performance of one or more risk evaluation operations on the organizational data, a risk score associated with provisioning the resource to the entity;
determining, by the computing system, a resource provisioning amount based at least in part on whether the risk score is below a risk threshold, wherein the resource provisioning amount comprises an amount of the resource authorized to be provisioned to the entity when the risk score is below the risk threshold, and wherein the amount is determined based at least in part on a relationship between the risk score and the amount or a requested amount for the resource, the requested amount being in the resource request data; and
generating, by the computing system, output comprising one or more indications associated with the resource provisioning amount.

16. The computer-implemented method of claim 15, wherein the one or more previous resource allocations are between the entity and another entity that is not associated with the organization.

17. The computer-implemented method of claim 15, wherein the request is associated with a request for disbursement of funds to the entity on behalf of the organization.

18. One or more tangible non-transitory computer-readable media storing computer-readable instructions that when executed by one or more processors cause the one or more processors to perform operations, the operations comprising:
accessing resource request data comprising information associated with a request for a resource from an entity associated with an organization, wherein the resource comprises access to payroll service portion of an organizational management platform;
accessing organizational data associated with the entity, wherein the organizational data comprises information associated with one or more risk factors of the entity;
determining, based at least in part on performance of one or more risk evaluation operations on the organizational data, a risk score associated with provisioning the resource to the entity;
determining a resource provisioning amount based at least in part on the risk score, wherein the resource provisioning amount comprises an approved level of access for the entity to the payroll service portion of the organizational management platform; and
generating output comprising one or more indications associated with the resource provisioning amount.

19. The one or more tangible non-transitory computer-readable media of claim 18, wherein the approved level of access for the entity to the payroll service portion of the organizational management platform comprises a zero access level of access.

20. The one or more tangible non-transitory computer-readable media of claim 18, wherein determining the resource provisioning amount based at least in part on the risk score comprises selecting one of a number of different payroll service product types for the entity based at least in part on the risk score.
